(19) United States
(12) Patent Application Publication
(10) Pub. No.: US 2024/0345904 A1
(43) Pub. Date: Oct. 17, 2024

(54) Automated Error Resolution in a Software Deployment Pipeline

(71) Applicant: Dell Products L.P., Round Rock, TX (US)

(72) Inventors: Polu Ram Charan Teja, Hyderabad (IN); Pratyush Paliwal, Deogarh (IN)

(21) Appl. No.: 18/134,066

(22) Filed: Apr. 13, 2023

(51) Int. Cl. G06F 11/07; G06F 40/205

(52) U.S. Cl. CPC G06F 11/0766; G06F 11/0793; G06F 40/205

(57) ABSTRACT

Techniques are provided for automated resolution of one or more pipeline errors. One method comprises obtaining information characterizing errors in a pipeline job of a software deployment pipeline; processing at least a portion of the information using a natural language processing model to identify an error resolution script that automatically addresses the errors in the pipeline job; and automatically initiating an execution of processing steps associated with the identified error resolution script to address the errors in the pipeline job. The information characterizing the errors in the pipeline job may be obtained by parsing error information in a job log. An error database may record a description of historical errors and a corresponding error resolution script. The natural language processing model may utilize information in the error database to identify an error resolution script that addresses a given error in a pipeline job.

### FIELD

The field relates generally to information processing systems and more particularly, to software development techniques in such systems.

### BACKGROUND

A number of techniques exist for developing and making changes to software code. GitHub, for example, provides a software development platform that enables communication and collaboration among software developers. The software development platform provided by GitHub allows software developers to create new versions of software without disrupting a current version. Software development tasks often require resolution of one or more errors in software jobs of a software development project.

### SUMMARY

In one embodiment, a method comprises obtaining information characterizing one or more errors in at least one pipeline job of a software deployment pipeline; processing at least a portion of the information using one or more natural language processing models to identify at least one error resolution script that automatically addresses at least one of the one or more errors in the at least one pipeline job; and automatically initiating an execution of one or more processing steps associated with the identified at least one error resolution script to address the at least one of the one or more errors in the at least one pipeline job.

In one or more embodiments, the information characterizing the one or more errors in the at least one pipeline job is obtained by parsing error information in a job log.

In some embodiments, the identifying the at least one error resolution script comprises identifying at least one record in an error database, wherein the error database comprises a plurality of records, wherein each record comprises an error description and a corresponding error resolution script pointer, and wherein the one or more natural language processing models process the information and the error descriptions of the error database to identify the at least one record. The one or more natural language processing models may be trained using the error description associated with at least a subset of the records in the error database and/or retrained using the error description associated with at least a subset of new records added to the error database.

In at least one embodiment, each record further comprises an error class associated with a given record, wherein at least one error class of the one or more errors is identified, from among a plurality of error classes, and wherein the processing the at least the portion of the information is based at least in part on the identified at least one error class. One or more errors associated with at least a first error class may be resolved automatically using one or more of the at least one error resolution script. One or more errors associated with at least a second error class may be (i) related to one or more of a periodic update and a new release of at least one software module used by the at least one pipeline job and (ii) resolved automatically using one or more of the at least one error resolution script. One or more errors associated with at least a third error class may be resolved at least in part by manual intervention.

Other illustrative embodiments include, without limitation, apparatus, systems, methods and computer program products comprising processor-readable storage media.

### BRIEF DESCRIPTION OF THE DRAWINGS

FIG. 1 illustrates an information processing system configured for automated error resolution in a software deployment pipeline, in accordance with an illustrative embodiment;

FIG. 2A shows an example of a software development lifecycle in an illustrative embodiment;

FIG. 2B shows an example of one or more pipeline jobs in various stages of a software deployment pipeline in an illustrative embodiment;

FIG. 3 illustrates a software development system configured for automated error resolution in a software deployment pipeline, in accordance with an illustrative embodiment;

FIG. 4 is a sample error table, in accordance with an illustrative embodiment;

FIG. 5 shows an example of at least portions of the software development lifecycle of FIG. 2A in further detail, in accordance with an illustrative embodiment;

FIGS. 6 and 7 are flow diagrams illustrating exemplary implementations of automated pipeline error resolution processes, in accordance with illustrative embodiments;

FIG. 8 is a flow chart illustrating an exemplary implementation of a process for automated error resolution in a software deployment pipeline, in accordance with an illustrative embodiment;

FIG. 9 illustrates an exemplary processing platform that may be used to implement at least a portion of one or more embodiments of the disclosure comprising a cloud infrastructure; and

FIG. 10 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for automated error resolution in a software deployment pipeline.

The term DevOps generally refers to a set of practices that combines software development and information technology (IT) operations. DevOps are increasingly being used to shorten the software development lifecycle and to provide continuous integration, continuous delivery, and continuous deployment. Continuous integration (CI) generally allows development teams to merge and verify changes more often by automating software generation (e.g., converting source code files into standalone software components that can be executed on a computing device) and software tests, so that errors can be detected and resolved early. Continuous delivery extends continuous integration and includes efficiently and safely deploying the changes into testing and production environments. Continuous deployment (CD) allows code changes that pass an automated testing phase to be automatically released into the production environment, thus making the changes visible to end users. Such processes are typically executed within a software generation and deployment pipeline.

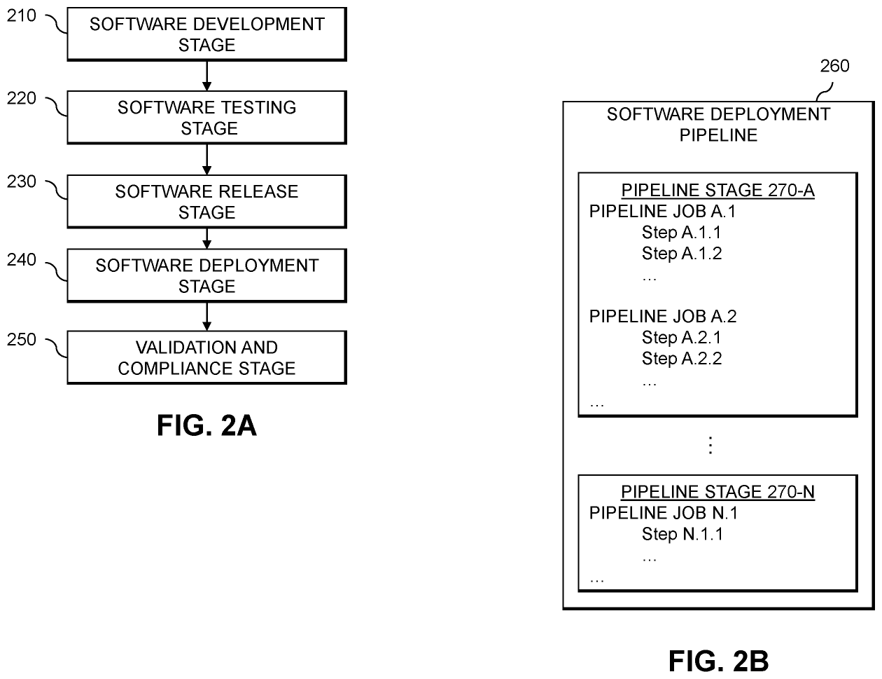

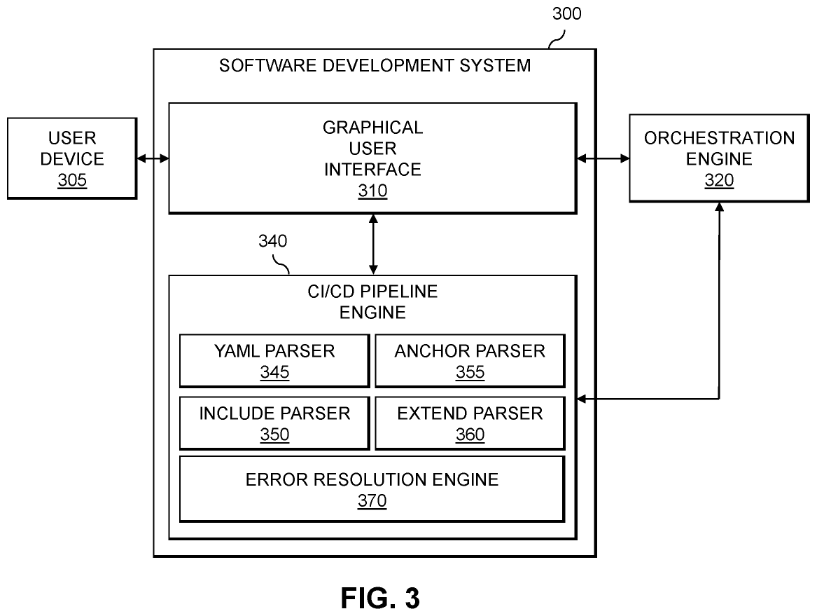

DevOps solutions typically employ blueprints that encompass continuous integration, continuous testing (CT), continuous deployment (also referred to as continuous development) and/or continuous change and management (CCM) abilities. DevOps blueprints allow development teams to efficiently innovate by automating workflows for a software development and delivery lifecycle. A typical software development lifecycle is discussed further below in conjunction with FIG. 2A.

A software deployment pipeline (sometimes referred to as a CI/CD pipeline) automates a software delivery process, and typically comprises a set of automated processes and tools that allow developers and an operations team to work together to generate and deploy application software code to a production environment. A preconfigured software deployment pipeline may comprise a specified set of elements and/or environments. Such elements and/or environments may be added or removed from the software deployment pipeline, for example, based at least in part on the software and/or compliance requirements. A software deployment pipeline typically comprises one or more quality control gates to ensure that software code does not get released to a production environment without satisfying a number of predefined testing and/or quality requirements. For example, a quality control gate may specify that software code should compile without errors and that all unit tests and functional user interface tests must pass.

One or more aspects of the disclosure recognize that one or more errors (e.g., a missed configuration, a missed detail and/or an omitted step) in a pipeline job can delay a release or a deployment of a related software product and/or increase a workload of DevOps personnel. While a resolution of some errors requires human intervention, many errors can be programmatically resolved.

Periodic updates and/or releases of a software product may include updating docker images and other utilities employed by a given organization, requiring corresponding changes in the software deployment pipelines of the organization. Such updates and/or releases of external tools being used in the projects of the organization may cause one or more software deployment pipelines to fail for one or more development teams in the organization.

In at least some embodiments, the disclosed error resolution techniques provide a terminal (e.g., a bash terminal on a user display that provides an integrated development environment (IDE)) to execute one or more selected pipeline jobs and to obtain real-time results. The user can use the IDE to issue job commands and obtain feedback. A user may optionally specify one or more breakpoints in a given pipeline job to pause and evaluate the execution. In this manner, the user can examine the values of variables, and step through execution of a given job script, e.g . . . line-by-line.

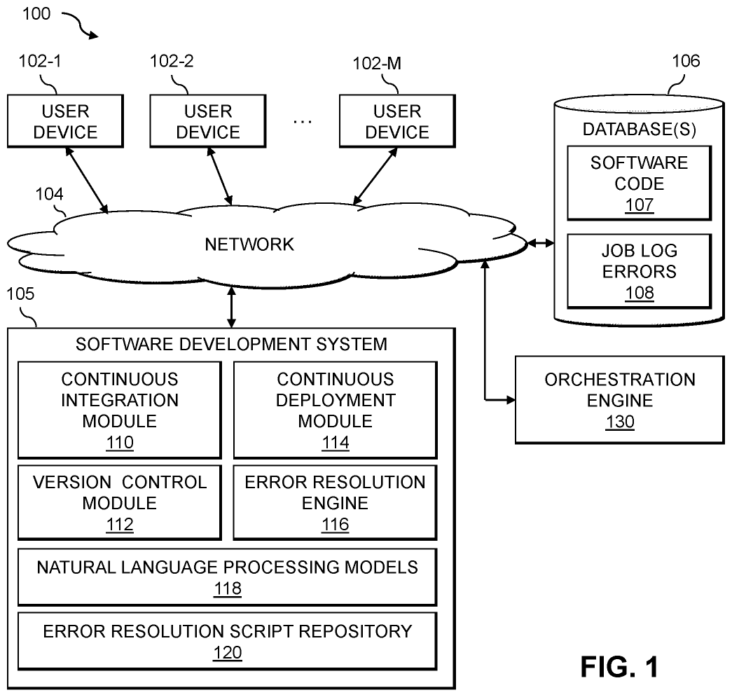

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 may be employed, for example, by software developers and other DevOps professionals to perform, for example, software development and/or software deployment tasks. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a software development system 105 and an orchestration engine 130.

The user devices 102 may comprise, for example, devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

The software development system 105 comprises a continuous integration module 110, a version control module 112, a continuous deployment module 114, an error resolution engine 116, one or more natural language processing models 118 and an error resolution script repository 120. Exemplary processes utilizing elements 110, 112, 114, 116, 118 and/or 120 will be described in more detail with reference to, for example, the flow diagrams of FIGS. 2A and 5 through 8.

In at least some embodiments, the continuous integration module 110, the version control module 112 and/or the continuous deployment module 114, or portions thereof, may be implemented using functionality provided, for example, by commercially available DevOps and/or CI/CD tools, such as the GitLab development platform, the GitHub development platform, the Azure DevOps server and/or the Bitbucket CI/CD tool, or another Git-based DevOps and/or CI/CD tool. The continuous integration module 110, the version control module 112 and the continuous deployment module 114 may be configured, for example, to perform CI/CD tasks and to provide access to DevOps tools and/or repositories. The continuous integration module 110 provides functionality for automating the integration of software code changes from multiple software developers or other DevOps professionals into a single software project.

In one or more embodiments, the version control module 112 manages canonical schemas (e.g., blueprints, job templates, and software scripts for jobs) and other aspects of the repository composition available from the DevOps and/or CI/CD tool. Source code management (SCM) techniques may be used to track modifications to a source code repository. In some embodiments, SCM techniques are employed to track a history of changes to a software code base and to resolve conflicts when merging updates from multiple software developers.

The continuous deployment module 114 manages the automatic release of software code changes made by one or more software developers from a software repository to a production environment, for example, after validating the stages of production have been completed. The continuous deployment module 114 may interact in some embodiments with the error resolution engine 116 to resolve one or more errors in a software deployment pipeline and/or to verify a successful testing of a software deployment pipeline.

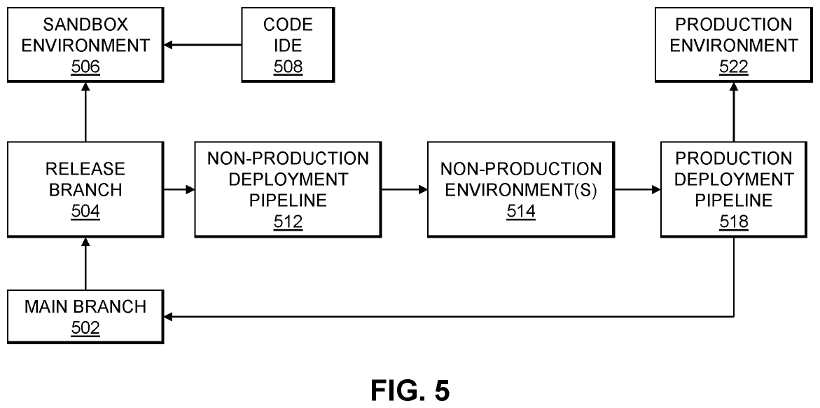

In at least some embodiments, the error resolution engine 116 may implement at least portions of the disclosed techniques for automated error resolution in a software deployment pipeline, as discussed further below in conjunction with, for example, FIGS. 4 and 6 through 8.

In one or more embodiments, the one or more natural language processing models 118 are used by the error resolution engine 116 to identify at least one error resolution script from the error resolution script repository 120 for automated pipeline error resolution, as discussed herein. The error resolution script repository 120 comprises error resolution scripts developed, for example, by one or more subject matter experts of a DevOps team, to automate the steps to be followed after a particular pipeline job error is encountered. The error resolution scripts in the error resolution script repository 120 may comprise details of automated steps to be followed for a given error, such as after a periodic release, to ensure a successful CI/CD pipeline run.

It is to be appreciated that this particular arrangement of elements 110, 112, 114, 116, 118 and/or 120 illustrated in the software development system 105 of the FIG. 1 embodiment is presented by way of example only, and alternative arrangements can be used in other embodiments. For example, the functionality associated with the elements 110, 112, 114, 116, 118 and/or 120 in other embodiments can be combined into a single module, or separated across a larger number of modules. As another example, multiple distinct processors can be used to implement different ones of the elements 110, 112, 114, 116, 118 and/or 120 or portions thereof.

At least portions of elements 110, 112, 114, 116, 118 and/or 120 may be implemented at least in part in the form of software that is stored in memory and executed by a processor.

In at least some embodiments, the orchestration engine 130 may be implemented, at least in part, using the functionality of Kubernetes®, Docker Swarm®, AmazonEKS® (Elastic Kubernetes Service), AmazonECS® (Elastic Container Service), and/or PKS® (Pivotal Container Service).

In one or more embodiments, the orchestration engine 130 may create execution environments using containers which provide a form of operating system virtualization. One container might be used to run a small microservice or a software process, as well as larger applications. The container provides the necessary executables, binary code, libraries, and configuration files. In some embodiments, the orchestration engine 130 may employ a PKS cluster (e.g., an enterprise Kubernetes platform) that enables developers to provision, operate and/or manage enterprise-level Kubernetes clusters to execute a pipeline job. The Docker open-source containerization platform may be leveraged in some embodiments for building, deploying, and/or managing containerized applications. Docker enables developers to package applications into containers-standardized executable components that combine application source code with operating system libraries and dependencies required to run that code in any environment.

Additionally, the software development system 105 can have at least one associated database 106 configured to store data pertaining to, for example, software code 107 of at least one application and a repository of one or more job log errors 108. For example, at least a portion of the at least one associated database 106 may correspond to at least one code repository that stores the software code 107. In such an example, the at least one code repository may include different snapshots or versions of the software code 107, at least some of which can correspond to different branches of the software code 107 used for different development environments (e.g., one or more testing environments, one or more staging environments, and/or one or more production environments). The job log errors 108 provide information characterizing one or more errors in at least one pipeline job of a software deployment pipeline, as discussed further below in conjunction with, for example, FIG. 4.

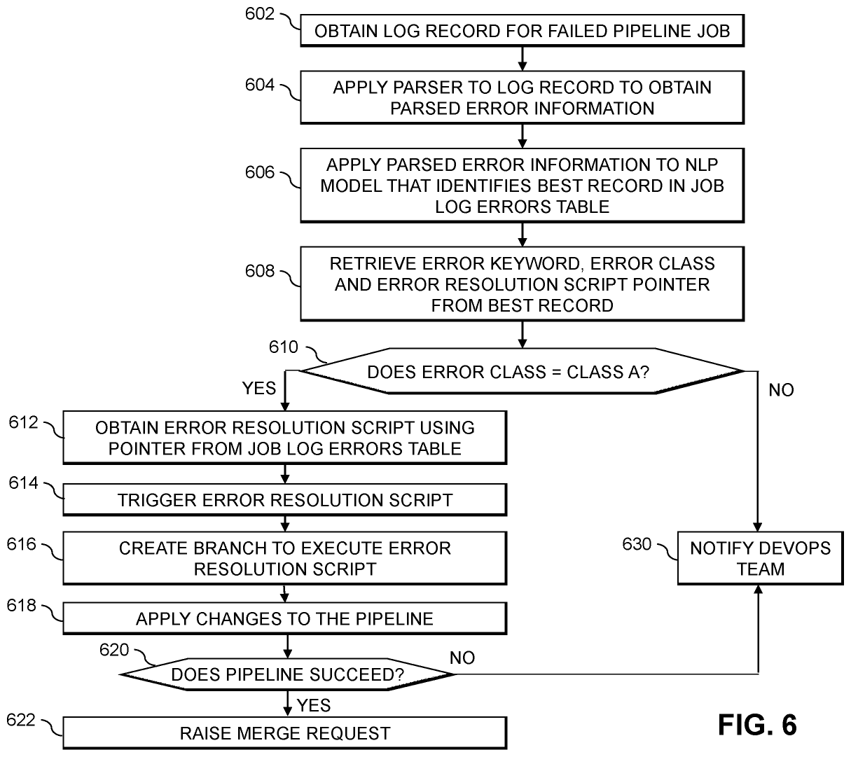

Also, at least a portion of the one or more user devices 102 can also have at least one associated database (not explicitly shown in FIG. 1). As an example, such a database can maintain a particular branch of the software code 107 that is developed in a sandbox environment associated with a given one of the user devices 102, as discussed further below in conjunction with FIG. 5. Any changes associated with that particular branch can then be sent and merged with branches of the software code 107 maintained in the at least one database 106, for example.

An example database 106, such as depicted in the present embodiment, can be implemented using one or more storage systems associated with the software development system 105. Such storage systems can comprise any of a variety of different types of storage including network-attached storage (NAS), storage area networks (SANS), direct-attached storage (DAS) and distributed DAS, as well as combinations of these and other storage types, including software-defined storage.

Also associated with the software development system 105 are one or more input-output devices, which illustratively comprise keyboards, displays or other types of input-output devices in any combination. Such input-output devices can be used, for example, to support one or more user interfaces to the software development system 105, as well as to support communication between software development system 105 and other related systems and devices not explicitly shown.

Additionally, the software development system 105 and/or the orchestration engine 130 in the FIG. 1 embodiment are assumed to be implemented using at least one processing device. Each such processing device generally comprises at least one processor and an associated memory, and implements one or more functional modules for controlling certain features of the software development system 105 and/or the orchestration engine 130.

More particularly, the software development system 105 and/or the orchestration engine 130 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the software development system 105 and/or the orchestration engine 130 to communicate over the network 104 with the user devices 102, and illustratively comprises one or more conventional transceivers.

It is to be understood that the particular set of elements shown in FIG. 1 for software development system 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the software development system 105 and database(s) 106 can be on and/or part of the same processing platform.

FIG. 2A shows an example of a software development lifecycle in an illustrative embodiment. A software development lifecycle is comprised of a number of stages 210 through 250. In the example of FIG. 2A, a software development stage 210 comprises generating (e.g., writing) the software code for a given application. A software testing stage 220 tests the application software code. A software release stage 230 comprises delivering the application software code to a repository. A software deployment stage 240 comprises deploying the application software code to a production environment. Finally, a validation and compliance stage 250 comprises the steps to validate a deployment, for example, based at least in part on the needs of a given organization. For example, image security scanning tools may be employed to ensure a quality of the deployed images by comparing them to known vulnerabilities, such as those known vulnerabilities in a catalog of common vulnerabilities and exposures (CVEs).

FIG. 2B shows an example of one or more pipeline jobs in various pipeline stages 270-A through 270-N (collectively, pipeline stages 270) of a software deployment pipeline 260 in an illustrative embodiment. The pipeline stages 270-A through 270-N of a software deployment pipeline 260 may correspond, for example, to the stages 210, 220, 230, 240 and 250 of the software development lifecycle of FIG. 2A.

In the example of FIG. 2B, each pipeline stage 270 is comprised of a plurality of pipeline jobs, such as pipeline jobs A.1 and A.2 for pipeline stage 270-A. Each pipeline job is comprised of one or more steps (e.g., tasks, scripts and/or a reference to an external template), such as steps A.1.1 and A.1.2 of pipeline job A.1 and steps A.2.1 and A.2.2 of pipeline job A.2.

In one or more embodiments, a pipeline can comprise one or more of the following elements: (i) local development environments (e.g., the computers of individual developers); (ii) a CI server (or a development server); (iii) one or more test servers (e.g., for functional user interface testing of the product); and (iv) a production environment. The pipelines may be defined, for example, in YAML (Yet Another Markup Language) with a set of commands executed in series to perform the necessary activities (e.g., the steps of each pipeline job).

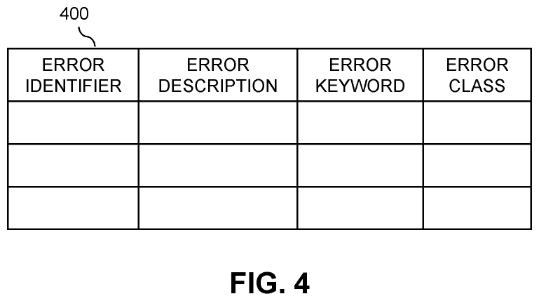

FIG. 3 illustrates a software development system 300 configured for automated error resolution in a software deployment pipeline, in accordance with an illustrative embodiment. As shown in FIG. 3, the software development system 300 comprises a graphical user interface (GUI) 310 and a CI/CD pipeline engine 340.

In addition, in at least some embodiments, a user employing a user device 305 utilizes the GUI 310 to interact with the software development system 300, such as one or more visual representations of a software deployment pipeline or components thereof (e.g., pipeline jobs). Generally, the GUI 310 provides access to a visual software deployment pipeline editor, a pipeline manager, a DevOps toolkit and a reusable CI/CD resource library, for example.

As shown in FIG. 3, the exemplary CI/CD pipeline engine 340 comprises a YAML parser 345, an include parser 350, an anchor parser 355, an extend parser 360, and an error resolution engine 370. The YAML parser 345 processes top-level YAML files obtained from one or more DevOps collaboration tools, for example, for conversion into a renderable format, such as a JSON (JavaScript Object Notation) file format. The include parser 350 processes files referenced in include statements in the YAML file (e.g., whereby a first YAML file calls a second YAML file). The anchor parser 355 processes references in the YAML file, such as variables, images and other configuration items. The extend parser 360 is employed when an include statement specifies a defined job that a user would like to extend (e.g., to extend or otherwise customize a preconfigured job defined, for example, in a blueprint). The error resolution engine 370 implements at least portions of the disclosed techniques for automated error resolution in a software deployment pipeline, as discussed further below.

In the example of FIG. 3, the GUI 310 interacts with the exemplary CI/CD pipeline engine 340 and the orchestration engine 320, and the exemplary CI/CD pipeline engine 340 and the orchestration engine 320 also interact with one another, in order to automatically resolve one or more pipeline errors, as discussed further below.

FIG. 4 is an error table 400, in accordance with an illustrative embodiment. In the example of FIG. 4, the error table 400 comprises for each anticipated error to be processed using the disclosed automated pipeline error resolution techniques, an identifier of the error, a description of the error, a keyword associated with the error and a designated class of the error. The keyword associated with the error, for example, may be mapped to a given error resolution script comprising a set of instructions to be followed for a specific error, such as a given version of a package or shared module release. The error resolution scripts may be named according to the corresponding keyword value associated with each dataset in the error resolution script repository 120, for example. In this manner, once the natural language processing models identify a given record of the error table 400, the corresponding error keyword may be used as a pointer or lookup value to obtain the correct error resolution script to resolve a given pipeline job error or set of pipeline job errors.

The designated error class may be obtained, for example, after analyzing the associated error resolution steps, and using input from DevOps subject matter experts, to classify the job log errors in the error table 400 into one of multiple designated error classes. The error table 400 may be updated, for example, before periodic releases of shared modules or package updates from a DevOps team.

The natural language processing models are trained using the information in the error table 400 and may be retrained for updates to the error table 400. For example, for a given error description, the natural language processing models may be trained to identify the corresponding error keyword (and thus, the corresponding error resolution script to execute to resolve the given error). For example, the natural language processing models may identify the record of the error table 400 with the best match based on the description provided for the given error.

The error table 400 thus provides a pointer to precalculated and documented error resolution steps for expected pipeline job errors (e.g., frequently encountered pipeline issues).

In this manner, the natural language processing models process information associated with a given pipeline job error and the error descriptions from the error table 400 to identify at least one record in the error table 400 that may be used to resolve the given pipeline job error. In some embodiments, an error class of the given pipeline job error may be identified, from among a plurality of designated error classes. The given pipeline job error is then processed based on the identified error class. Errors associated with at least a first error class (e.g., Class A) may be resolved automatically using a corresponding error resolution script. Errors associated with a second error class (e.g., Class B) may be (i) related to a periodic update and/or a new release of a software module used by a given pipeline job and (ii) resolved automatically using a designated error resolution script. A third error class (e.g., Class C) may be resolved using manual techniques. Some errors may be resolved using a combination of automated error resolution techniques and manual error resolution techniques.

FIG. 5 shows an example of at least portions of the software development lifecycle of FIG. 2A in further detail in an illustrative embodiment. In the FIG. 5 example, a main branch 502 corresponds to software code of at least one software application. A release branch 504 is created based on the main branch 502. For example, the release branch 504 may be created based on development release timelines corresponding to the software application.

One or more developers (e.g., corresponding to user devices 102) create respective personal branches based on the release branch 504, and perform development work using a sandbox environment 506 and a code IDE (integration development environment) 508. Many developers prefer to write software code using such an IDE that allows the software to be developed in any programming language without having to deal with a particular language syntax. Developers may have multiple IDEs available for application development but there is currently no IDE available for writing software deployment pipeline code.

Developers can commit the changes made in their personal branches to the release branch 504. In the FIG. 5 example, a non-production deployment pipeline 512 is triggered according to one or more specified schedules. The non-production deployment pipeline 512 deploys any changes resulting from the change requests to one or more non-production environments 514.

In some examples, the non-production environment(s) 514 may include one or more of: a developer integration testing (DIT) environment, a system integration testing (SIT) environment, and a global environment. As noted above, the non-production deployment pipeline 512 may be triggered according to schedules defined for each of the non-production environments 514 (e.g., a first schedule for a DIT environment and a second schedule for an SIT environment).

A production deployment pipeline 518 can be triggered when the release branch 504 of the application is ready to be deployed to a production environment 522. Generally, the production deployment pipeline 518 collects any changes that were made to the release branch 504, creates a deployment package, and deploys the package to the production environment 522.

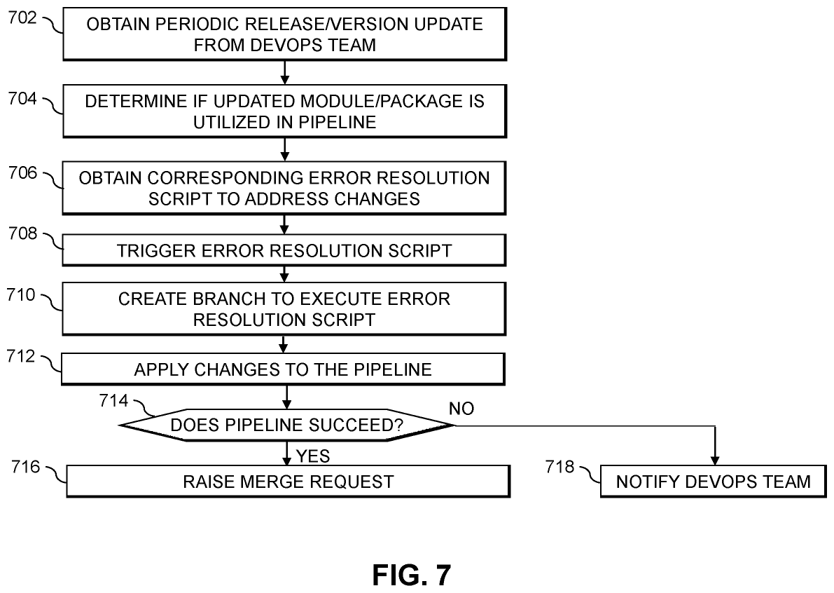

FIG. 6 is a flow diagram illustrating an exemplary implementation of an automated pipeline error resolution process, in accordance with an illustrative embodiment. In the example of FIG. 6, a log record is obtained in step 602 for a failed pipeline job (e.g., a pipeline job comprising an error). A parser is applied to the log record in step 604 to obtain parsed error information (e.g., transforming the obtained error information into a designated format, or otherwise cleaning or preprocessing the log record). The parsed error information is applied to the natural language processing model in step 606 that identifies best record in the job log errors table (e.g., a best matching record in the error table 400). For example, the natural language processing model may employ cosine similarity techniques that identify a closest match in the job log errors table to the log record for the failed pipeline job. The error keyword, error class and error resolution script pointer are retrieved from the identified record of the job log errors table in step 608.

A test is performed in step 610 to determine if the error class of the error is Class A (for example). If it is determined in step 610 that the error class of the error is not Class A, then the error is processed as a Class B error, for example, and the DevOps team is notified of the error in step 630, for example, to be resolved at least partially using manual techniques.

If it is determined in step 610 that the error class of the error is Class A, then the error resolution script corresponding the error (e.g., identified using the error keyword from the error table 400 identified by the natural language processing model) is obtained from the job log errors table in step 612. The obtained error resolution script is then triggered in step 614 and a branch is created in step 616 to execute the obtained error resolution script. The changes generated by the executed error resolution script are then applied to the pipeline in step 618.

A test is performed in step 620 to determine if the pipeline succeeds. If it is determined in step 620 that the pipeline succeeds, then a merge request is raised in step 622.

If, however, it is determined in step 620 that the pipeline does not succeed, then program control proceeds to step 630, where the DevOps team is notified of the error, for example, to be resolved at least partially using manual techniques.

FIG. 7 is a flow diagram illustrating an exemplary implementation of an automated pipeline error resolution process, in accordance with an illustrative embodiment. The process of FIG. 7 may be applied, for example, to resolve pipeline errors associated with periodic updates and/or releases of shared software modules. In the example of FIG. 7, a periodic release and/or a version update is obtained from the DevOps team in step 702. An evaluation is performed in step 704 to determine if the updated module and/or package is utilized in a current pipeline.

When the updated module and/or package is utilized in the current pipeline, the corresponding error resolution script is obtained in step 706 (e.g., using the pointer obtained from the identified record in the job log errors table). The error resolution script is triggered in step 708 and a new branch is created in step 710 to execute the obtained error resolution script. The changes are applied to the pipeline in step 712.

A test is performed in step 714 to determine if the pipeline succeeds. If it is determined in step 714 that the pipeline succeeds, then a merge request is raised in step 716.

If, however, it is determined in step 714 that the pipeline does not succeed, then program control proceeds to step 718, where the DevOps team is notified of the error, for example, to be resolved at least partially using manual techniques.

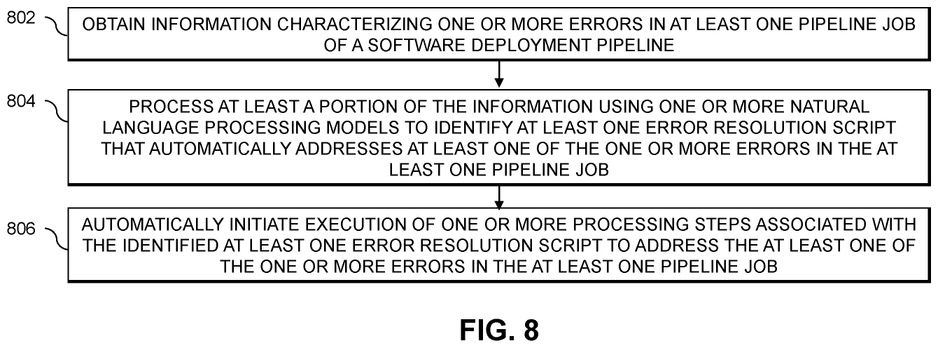

FIG. 8 is a flow chart illustrating an exemplary implementation of a process for automated error resolution in a software deployment pipeline, in accordance with an illustrative embodiment. In the example of FIG. 8, information characterizing one or more errors in at least one pipeline job of a software deployment pipeline is obtained in step 802.

At least a portion of the information is processed in step 804 using one or more natural language processing models to identify at least one error resolution script that automatically addresses at least one of the one or more errors in the at least one pipeline job. One or more processing steps associated with the identified at least one error resolution script are automatically initiated in step 806 to address the at least one of the one or more errors in the at least one pipeline job.

In one or more embodiments, the information characterizing the one or more errors in the at least one pipeline job is obtained by parsing error information in a job log. In some embodiments, the identifying the at least one error resolution script comprises identifying at least one record in an error database, wherein the error database comprises a plurality of records, wherein each record comprises an error description and a corresponding error resolution script pointer, and wherein the one or more natural language processing models process the information and the error descriptions of the error database to identify the at least one record. The one or more natural language processing models may be trained using the error description associated with at least a subset of the records in the error database and/or retrained using the error description associated with at least a subset of new records added to the error database.

In at least one embodiment, each record further comprises an error class associated with a given record, wherein at least one error class of the one or more errors is identified, from among a plurality of error classes, and wherein the processing the at least the portion of the information is based at least in part on the identified at least one error class. One or more errors associated with at least a first error class may be resolved automatically using one or more of the at least one error resolution script. One or more errors associated with at least a second error class may be (i) related to one or more of a periodic update and a new release of at least one software module used by the at least one pipeline job and (ii) resolved automatically using one or more of the at least one error resolution script. One or more errors associated with at least a third error class may be resolved at least in part by manual intervention.

The particular processing operations and other network functionality described in conjunction with the flow diagrams of FIGS. 2A and 5 through 8, for example, are presented by way of illustrative example only, and should not be construed as limiting the scope of the disclosure in any way. Alternative embodiments can use other types of processing operations to provide functionality for automated resolution of one or more pipeline errors. For example, the ordering of the process steps may be varied in other embodiments, or certain steps may be performed concurrently with one another rather than serially. In one aspect, the process can skip one or more of the actions. In other aspects, one or more of the actions are performed simultaneously. In some aspects, additional actions can be performed.

In one or more embodiments, a proactive error resolution approach is provided that provides consistency in a CI/CD setup, for example, after periodic updates and/or releases of software shared modules, by providing one or more error resolution scripts that automate a set of practices provided, for example, by a DevOps team. For example, if a given pipeline job employs a particular version of Angular software (e.g., version 8), and the DevOps team has updated the deployed version of Angular software to a new version (e.g., version 12), then upon building the given pipeline job, an “angular mismatch” error may be received. A corresponding error resolution script may be provided by the present disclosure that is used to install a proper version in the given pipeline job. For example, the error resolution script may update an image being used to a latest release tag suggested by the DevOps support team.

In this manner, the disclosed automated pipeline error resolution techniques improve stability in the CI/CD pipeline,

In the event of such a periodic release, the disclosed automated pipeline error resolution techniques may first identify and confirm the use of such modules in the pipeline (e.g., in a specific branch), for example, using a dependency chart for the corresponding software development project. When new docker images are created, some older docker images may be deprecated (or otherwise removed from the system).

It should also be understood that the disclosed techniques for automated error resolution in a software deployment pipeline can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for automated resolution of one or more pipeline errors may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services and/or storage services can be offered to cloud infrastructure tenants or other system users as a Platform-as-a-Service (PaaS) model, an Infrastructure-as-a-Service (IaaS) model, a Storage-as-a-Service (STaaS) model and/or a Function-as-a-Service (FaaS) model, although it is to be appreciated that numerous other cloud infrastructure arrangements could be used.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based automated pipeline error resolution engine, or portions thereof, are illustratively implemented for use by tenants of such a multi-tenant environment.

Cloud infrastructure as disclosed herein can include cloud-based systems such as Amazon Web Services (AWS), Google Cloud Platform (GCP) and Microsoft Azure. Virtual machines provided in such systems can be used to implement at least portions of a automated pipeline error resolution platform in illustrative embodiments. The cloud-based systems can include object stores such as Amazon S3, GCP Cloud Storage, and Microsoft Azure Blob Storage.

In some embodiments, the cloud infrastructure additionally or alternatively comprises a plurality of containers implemented using container host devices. For example, a given container of cloud infrastructure illustratively comprises a Docker container or other type of Linux Container. The containers may run on virtual machines in a multi-tenant environment, although other arrangements are possible. The containers may be utilized to implement a variety of different types of functionalities within the storage devices. For example, containers can be used to implement respective processing devices providing compute services of a cloud-based system. Again, containers may be used in combination with other virtualization infrastructure such as virtual machines implemented using a hypervisor.

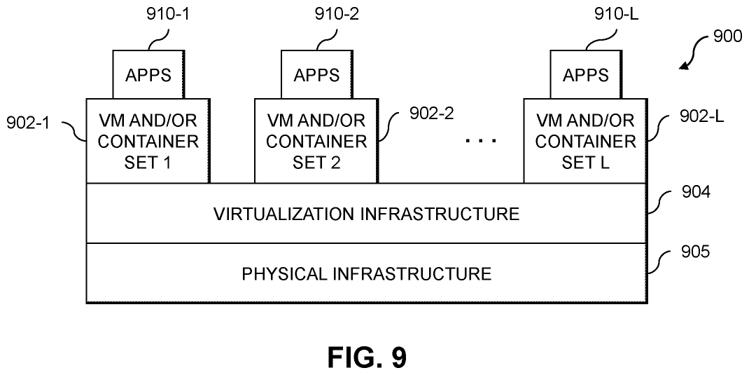

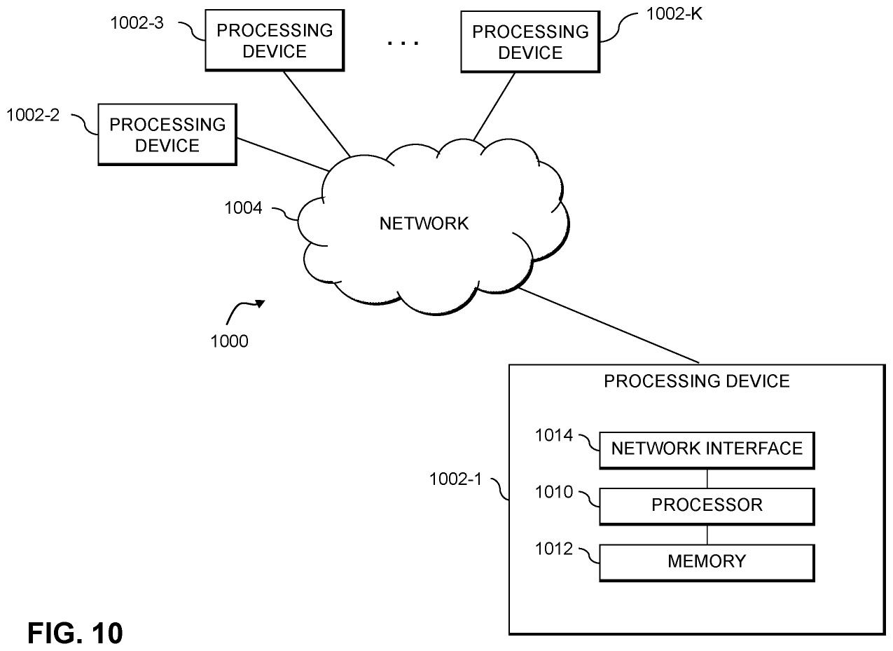

Illustrative embodiments of processing platforms will now be described in greater detail with reference to FIGS. 9 and 10. These platforms may also be used to implement at least portions of other information processing systems in other embodiments.

FIG. 9 shows an example processing platform comprising cloud infrastructure 900. The cloud infrastructure 900 comprises a combination of physical and virtual processing resources that may be utilized to implement at least a portion of the information processing system 100. The cloud infrastructure 900 comprises multiple VMs and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 may comprise respective VMs, respective sets of one or more containers, or respective sets of one or more containers running in VMs.

In some implementations of the FIG. 9 embodiment, the VMs/container sets 902 comprise respective VMs implemented using virtualization infrastructure 904 that comprises at least one hypervisor. Such implementations can provide automated pipeline error resolution functionality of the type described above for one or more processes running on a given one of the VMs. For example, each of the VMs can implement automated pipeline error resolution control logic and associated software deployment pipeline recommendation functionality for one or more processes running on that particular VM.

An example of a hypervisor platform that may be used to implement a hypervisor within the virtualization infrastructure 904 is the VMwareR vSphereR which may have an associated virtual infrastructure management system such as the VMwareR vCenterIM. The underlying physical machines may comprise one or more distributed processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system. Such implementations can provide automated pipeline error resolution functionality of the type described above for one or more processes running on different ones of the containers. For example, a container host device supporting multiple containers of one or more container sets can implement one or more instances of automated pipeline error resolution control logic and associated software deployment pipeline recommendation functionality.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises at least a portion of the given system and includes a plurality of processing devices, denoted 1002-1, 1002-2, 1002-3, . . . 1002-K, which communicate with one another over a network 1004. The network 1004 may comprise any type of network, such as a WAN, a LAN, a satellite network, a telephone or cable network, a cellular network, a wireless network such as WiFi or WiMAX, or various portions or combinations of these and other types of networks.

The processing device 1002-1 in the processing platform 1000 comprises a processor 1010 coupled to a memory 1012. The processor 1010 may comprise a microprocessor, a microcontroller, an ASIC, an FPGA or other type of processing circuitry, as well as portions or combinations of such circuitry elements, and the memory 1012, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 9 or 10, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining information characterizing one or more errors in at least one pipeline job of a software deployment pipeline;
processing at least a portion of the information using one or more natural language processing models to identify at least one error resolution script that automatically addresses at least one of the one or more errors in the at least one pipeline job; and
automatically initiating an execution of one or more processing steps associated with the identified at least one error resolution script to address the at least one of the one or more errors in the at least one pipeline job;
wherein the method is performed by at least one processing device comprising a processor coupled to a memory.

2. The method of claim 1, wherein the information characterizing the one or more errors in the at least one pipeline job is obtained by parsing error information in a job log.

3. The method of claim 1, wherein the identifying the at least one error resolution script comprises identifying at least one record in an error database, wherein the error database comprises a plurality of records, wherein each record comprises an error description and a corresponding error resolution script pointer, and wherein the one or more natural language processing models process the information and the error descriptions of the error database to identify the at least one record.

4. The method of claim 3, wherein the one or more natural language processing models are one or more of trained using the error description associated with at least a subset of the records in the error database and retrained using the error description associated with at least a subset of new records added to the error database.

5. The method of claim 3, wherein each record further comprises an error class associated with a given record, wherein at least one error class of the one or more errors is identified, from among a plurality of error classes, and wherein the processing the at least the portion of the information is based at least in part on the identified at least one error class.

6. The method of claim 5, wherein one or more errors associated with at least a first error class are resolved automatically using one or more of the at least one error resolution script.

7. The method of claim 5, wherein one or more errors associated with at least a second error class are (i) related to one or more of a periodic update and a new release of at least one software module used by the at least one pipeline job and (ii) resolved automatically using one or more of the at least one error resolution script.

8. The method of claim 5, wherein one or more errors associated with at least a third error class are resolved at least in part by manual intervention.

9. An apparatus comprising:
at least one processing device comprising a processor coupled to a memory;
the at least one processing device being configured to implement the following steps:
obtaining information characterizing one or more errors in at least one pipeline job of a software deployment pipeline;
processing at least a portion of the information using one or more natural language processing models to identify at least one error resolution script that automatically addresses at least one of the one or more errors in the at least one pipeline job; and
automatically initiating an execution of one or more processing steps associated with the identified at least one error resolution script to address the at least one of the one or more errors in the at least one pipeline job.

10. The apparatus of claim 9, wherein the identifying the at least one error resolution script comprises identifying at least one record in an error database, wherein the error database comprises a plurality of records, wherein each record comprises an error description and a corresponding error resolution script pointer, and wherein the one or more natural language processing models process the information and the error descriptions of the error database to identify the at least one record.

11. The apparatus of claim 10, wherein each record further comprises an error class associated with a given record, wherein at least one error class of the one or more errors is identified, from among a plurality of error classes, and wherein the processing the at least the portion of the information is based at least in part on the identified at least one error class.

12. The apparatus of claim 11, wherein one or more errors associated with at least a first error class are resolved automatically using one or more of the at least one error resolution script.

13. The apparatus of claim 11, wherein one or more errors associated with at least a second error class are (i) related to one or more of a periodic update and a new release of at least one software module used by the at least one pipeline job and (ii) resolved automatically using one or more of the at least one error resolution script.

14. The apparatus of claim 11, wherein one or more errors associated with at least a third error class are resolved at least in part by manual intervention.

15. A non-transitory processor-readable storage medium having stored therein program code of one or more software programs, wherein the program code when executed by at least one processing device causes the at least one processing device to perform the following steps:
obtaining information characterizing one or more errors in at least one pipeline job of a software deployment pipeline;
processing at least a of the information using one or more natural language processing models to identify at least one error resolution script that automatically addresses at least one of the one or more errors in the at least one pipeline job; and
automatically initiating an execution of one or more processing steps associated with the identified at least one error resolution script to address the at least one of the one or more errors in the at least one pipeline job.

16. The non-transitory processor-readable storage medium of claim 15, wherein the identifying the at least one error resolution script comprises identifying at least one record in an error database, wherein the error database comprises a plurality of records, wherein each record comprises an error description and a corresponding error resolution script pointer, and wherein the one or more natural language processing models process the information and the error descriptions of the error database to identify the at least one record.

17. The non-transitory processor-readable storage medium of claim 16, wherein each record further comprises an error class associated with a given record, wherein at least one error class of the one or more errors is identified, from among a plurality of error classes, and wherein the processing the at least the portion of the information is based at least in part on the identified at least one error class.

18. The non-transitory processor-readable storage medium of claim 17, wherein one or more errors associated with at least a first error class are resolved automatically using one or more of the at least one error resolution script.

19. The non-transitory processor-readable storage medium of claim 17, wherein one or more errors associated with at least a second error class are (i) related to one or more of a periodic update and a new release of at least one software module used by the at least one pipeline job and (ii) resolved automatically using one or more of the at least one error resolution script.

20. The non-transitory processor-readable storage medium of claim 17, wherein one or more errors associated with at least a third error class are resolved at least in part by manual intervention.
